(19) United States
(12) Patent Application Publication
(10) Pub. No.: US 2020/0037637 A1
(43) Pub. Date: Feb. 6, 2020

(54) INSTANT DISSOLVING SUPPLEMENT DELIVERY MECHANISM

(71) Applicant: Andrew Marsch, Glen Ellyn, IL (US)

(72) Inventor: Andrew Marsch, Glen Ellyn, IL (US)

(21) Appl. No.: 16/052,550

(22) Filed: Aug. 1, 2018

(51) Int. Cl. A23L 2/395

(52) U.S. Cl. CPC A23L 2/395; A23V 2002/00; A23V 2250/6406; A23V 2200/238; A23V 2250/1842; A23V 2200/224

(57) ABSTRACT

The invention is a mechanism, sized for insertion into a commercially-available water bottle, for instantaneously producing a water-based beverage without spillage that comprises a concentrate fully encompassed by an instantaneously dissolvable water-soluble film with water-soluble access members about the film that have a faster water-dissolution rate than the film. The film is thick enough to retain the concentrate when at room temperature and not in contact with water, but thin enough to dissolve very quickly, e.g. within five seconds, when contacted with water.

### BACKGROUND

### Field of the Invention

This invention is related to a mechanism for the storage, packaging and delivery of water dispersible concentrated products into beverage bottles, e.g. water bottles and sports drink bottles. Examples of such products include flavorants, nutritional supplements, food products, colorants, medications, herbs, or oil-based liquids.

### Description of the Related Art

There are a number of nutritional supplements, drinks, and other medicaments currently available in concentrated powder form for suspension or dissolution in water to form a palatable and readily ingestible product. Dissolving the products in water facilitates their subsequent absorption in the body. To enhance the palatability of the drink, the medicament may be combined with colorants, flavorings and/or sweeteners, or with an effervescent mixture which results in the drink being carbonated.

These concentrated powders, while beneficial in many ways, such as clean preparation, pre-measurement, storage and transport, are avoided by many because they are messy to use. Users often spill some portion of the powder whilst trying to introduce the powders into their drinks. The spillage is generally related to difficulty in opening the storage package, and the small diameter of the water bottle or other container that the user desires to use for preparation of the drink. The drinks are often colored, which may cause staining to the user, or other surfaces that come into contact with the spilled powder.

Some powders are also sold in bulk and a scoop is provided to help the user transport the powder into the base. This is even more messy largely due to the large diameter of the scoop compared to the storage container that will house the prepared drink. These bulk containers are also difficult to transport, generally.

What differentiates the present invention is that the concentrate is fully encompassed within a water-dissolvable film 20 tube that is sized and shaped to easily fit into the top of the average water bottle. The film maintains its integrity while being held, stored and transported, only releasing the concentrate when in contact with water. This prevents spillage, while maintaining the benefits of single-service pre-packaging, including clean-preparation, pre-measurement, easy transport and storage.

### SUMMARY

One object of the present invention is to provide a spill-proof delivery mechanism for concentrated nutritional supplements and the like that does not require agitation or a catalyst to rapidly be dissolved inside commercial water bottles at room temperature. This object and others are met by the present invention, which, in one embodiment is an indissoluble and dispersible concentrate fully encompassed within an immediately dissolvable water-soluble film. The water-soluble film has at least one water-soluble access member therewithin with a water dissolution rate higher than the water dissolution rate of the film. Access members are adapted to allow the concentrate to escape the film prior to the dissolution of the film when the film is contacted with water and is of a thickness sufficient to retain the concentrate within film 20 when not in contact with water. The film is of a thickness sufficient for structural integrity and dissolution within 5 seconds of water contact.

In another embodiment, the invention is an instant dissolving delivery mechanism that includes an indissoluble and dispersible nutritional supplement concentrate fully encompassed within an immediately dissolvable water-soluble film formed in a cylindrical shape with two opposite ends and at least one water-soluble access member comprised of sugar fibers therewithin. Access members are at opposite ends of the mechanism and have a water dissolution rate higher than the water dissolution rate of the water-soluble film. Access members are specifically adapted to allow the concentrate to escape the film prior to the dissolution of the film when the film is contacted with water. The film is of a thickness sufficient for structural integrity and dissolution within five seconds of water contact. The cylindrical shape of the film forms a tube that has a diameter of about 0.75 inches and the access member has a diameter of about 0.75 inches and a thickness of about 0.25 inches. The water-soluble film is in the range of about 0.0005 and 0.015 inches thick.

In a further embodiment of the invention, a method for making a beverage from a concentrate includes placing the mechanisms in contact with water.

### BRIEF DESCRIPTION OF THE DRAWINGS

FIG. 1 is a plan view of one embodiment of the invention wherein the mechanism is cylindrical in shape and comprises access means about each end.

FIG. 2 is a cut-out view of the embodiment of the invention illustrated in FIG. 1.

FIG. 3 is a plan view of various embodiments of the invention.

### DETAILED DESCRIPTION

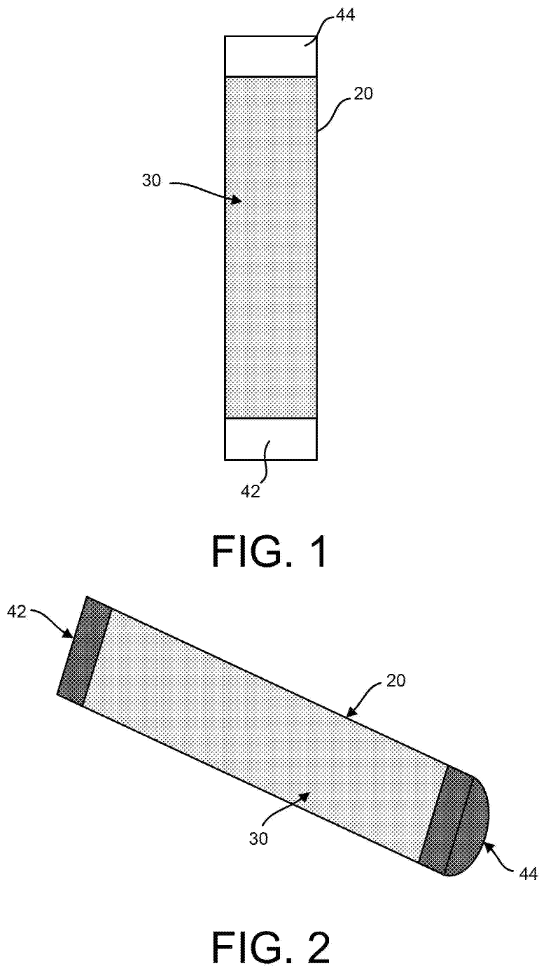

With reference to FIGS. 1 and 2, and in one embodiment of the invention, an instantly dissolving delivery mechanism to is described that comprises an immediately dissolvable water-soluble film 20 that includes an indissoluble and dispersible concentrate 30 within its walls. The tube is formed by fully encompassing concentrate 30 within the walls of immediately dissolvable water-soluble film 20 and providing at least one water-soluble access member 42, 44, the members 42, 44 having a water dissolution rate higher than the water dissolution rate of film 20 and being adapted to allow concentrate 30 to escape film 20 prior to the dissolution of film 20 when in contact with water. As used herein, “immediately dissolvable” means having the ability to fully dissolve less than five seconds after exposure to a water without a catalyst, or motion, e.g. a blender, shaker, or user agitation. The at least one access member 42, 44 is of a thickness sufficient to retain the concentrate within the film when the film is not in contact with water. This allows for proper storage and transport of mechanism 10. Film 20 employed is sufficiently thick for structural integrity during handling and dissolution within five seconds of water contact.

In one embodiment of the invention, shown in FIGS. 1 and 2, water-soluble film 20 is generally cylindrical in shape with two access members at each end. The shape of the mechanism must allow easy passage through a commercially available water bottle but is not otherwise constrained by shape. In one embodiment of the invention, the cylindrical shape has a diameter in the range of about 0.25 to about 1.16 inches. In a specific embodiment of the invention, the cylindrical shape has a diameter of less than about 0.075 inches. In another specific embodiment of the invention, the cylindrical shape has a diameter up to about 1.16 inches. In a more specific embodiment of the invention the cylindrical shape has a diameter of less than about 0.85 inches.

Some commercially-available water-based substances have a wider mouth and hold more volume than typical 16 ounce water-bottles. As such, and in yet another specific embodiment of the invention, film 20 forms a cylindrical shape, which is up to about 1.16 inches in diameter. It should be noted that all references to the diameter of the mechanism 10 should be taken from a cross-section of one end of the mechanism 10. In this specific embodiment, film 20 creates a tube that is up to about six inches long, when measured from a side view and about 126 milliliters (“ml”) of concentrate 30 is encompassed within film 20. In a more specific embodiment, mechanism 10 is about six inches long.

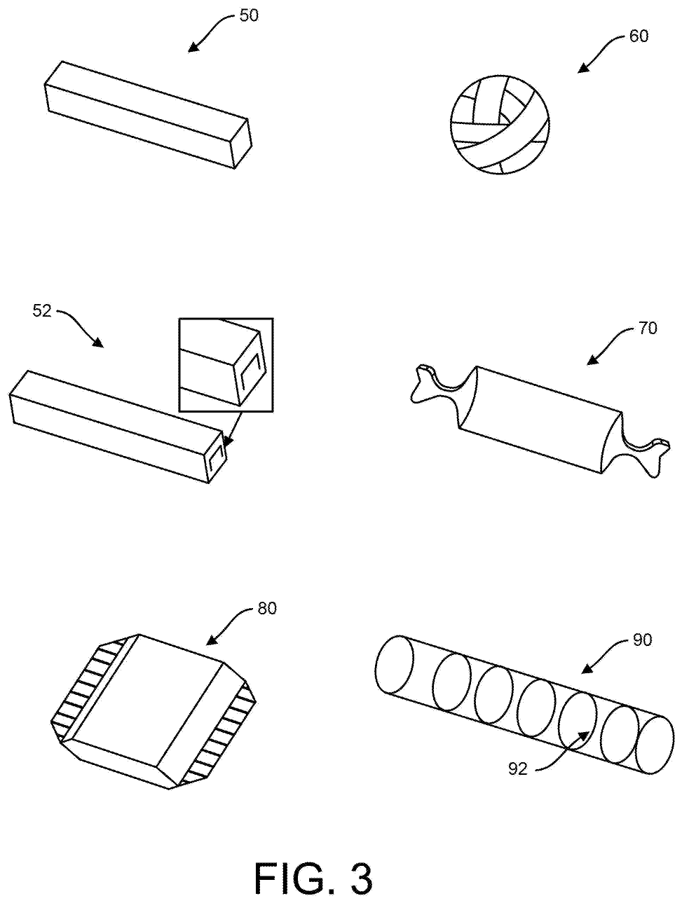

In other embodiments of the invention illustrated in FIG. 3, mechanism 10 is at least one shape from a group of shapes including a rectangular prism 50, a sphere 60, a cylinder with twisted ends 70, a rectangular prism with folded/sealed ends 52, a package with sealed and cut ends 80, or a cylindrical shape 90 with film wafers 92 inside. Again, the shape may be any shape, but the overall dimensions of the mechanism must allow for easy introduction into the average commercially-available water bottle, e.g. a diameter of less than about 0.75 inches.

The specific embodiment of the invention that employs wafers 92 within water-soluble film 20 allows for increased structural rigidity. Wafers 92 have a rate of water dissolution that is less than both access members 42, 44 as well as water-soluble film 20. Only concentrate 30 that is in closest proximity to access members 42, 44 will be released until each wafer 92 dissolves. Wafers 92 may each have different rates of water dissolution from one another.

In accordance with the various embodiments of the invention, access members 42, 44 may be open, or may be concealed as described herein.

Glycerin and gelatin materials are not suitable for use as the film of the invention because of its rate of dissolution. Mechanism to is designed to instantaneously dissolve when contacted with water. Films 20 containing glycerin will not dissolve instantaneously and are adapted for slow-dissolution. As such, it would not address the concerns addressed by the current invention.

The thickness of film 20 employed must be in the range of about 0.0005 inches to about 0.025 inches to allow proper dissolution upon contact with water. It is a key object that the mechanisms to of the invention dissolve immediately, so the thickness of film 20 is critical to its function. In specific embodiments of the invention, the thickness of film 20 is the range of about 0.0005 inches to 0.015 inches.

Films 20 suitable for use in the present invention include, but are not limited to starch-based emulsions containing lecithin and glycerol or at least one glycerol-based oil.

Any water-soluble, edible polyvinyl acetate film that dissolves immediately, e.g. within five or less seconds, may be used in accordance with the various embodiments of the invention.

In specific embodiments of the invention, film 20 is at least one of a polysaccharide film, a protein film, a lipid film, a food safe polyvinyl alcohol film, a piroxicam-containing film, and a microcrystalline cellulose and maltodextrin-containing film. In various embodiments of the invention, the polysaccharide film may comprise at least one of starch and/or one if its derivatives, chitosan, pectin, cellulose and its derivatives, alginate, carrageenan and cassava. In other various embodiments of the invention, the protein film may comprise at least one of collagen, gelatin, casein, gluten and zein.

Concentrate 30 may be any concentrate adapted for mixing with water, including nutritional supplements and the like. The concentrate may be liquid or solid, e.g. powders, gels. However, the concentrate may not be water-based. The concentrate may include other non-water-based components in various embodiments of the invention, including, but not limited to flavorants, aromatic components, colorants, natural or artificial sweeteners, suspending agents such as beeswax, hydrogenated vegetables oils, glycerol monostearate or glycerol palmitate, and high molecular weight polyethylene glycol (“PEG”).

Artificial sweeteners including, but are not limited to aspartame, saccharin, acesulphame K, neohesperidine, taste-making ingredients such as sodium bicarbonate, ion exchange resins, cyclodextrins and adsorbates.

Where concentrates 30 include suspended particles, the particles may be separately coated, typically with suitably sweetened or flavored coatings. It should be noted that the film of the invention does not include any additional components described herein because the addition of additional substances may negatively affect the dissolution rate and inhibit instant dissolution of the film when contacted with water.

Any amount of concentrate may be employed, provided the size of mechanism 10 is consistent with the size constraints described herein. In one embodiment of the invention, mechanism 10 comprises in the range of about 1-160 ml concentrate 30. In one embodiment of the invention, mechanism to comprises about 42 ml concentrate 30.

U.S. Pat. No. 7,854,192 to Densisart et. al. describes a method for wetting and/or dissolving a substance contained in a capsule for producing a beverage by piercing and pressure injecting. The methods described therein are not suitable for the mechanisms of this invention because the film lacks the integrity to withstand the described methods due to its thinness.

Other prior art devices encapsulate products within a water-soluble film. These devices employ films that do not dissolve without agitation at room temperature and many do not have the structural integrity at room temperature to be transported or inserted into water bottles on the go.

Access members 42, 44 dissolve more rapidly than the film when contacted with water. This allows concentrate 30 to be released prior to the dissolution of the film, which allows concentrate 30 to begin to mix with the water as quickly as possible. In the case of a beverage, or supplement, a user would want the concentrate to be introduced into the water as soon as possible so that it could be in suspension and ready for ingestion as quickly as possible. In one embodiment of the invention illustrated in FIG. 2, access members 42, 44 are comprised of sugar fibers, which form caps that retain the concentrate within the film when it is not in contact with water.

In specific embodiments of the invention, illustrated in FIG. 2, the sugar fibers form at least one cap that is about 0.25 inches in thickness and have a diameter that is about the same diameter as the mechanism. It will be appreciated by those skilled in the art that the caps formed by sugar fibers may be of sufficient thickness to retain the concentrate within water-soluble film 20, when not in contact with water, but thin enough to allow for the sugar fibers to dissolve at a faster rate than water-soluble film 20.

Access members 42, 44 dissolve on contact with water. As used herein, “on contact” means within 1 second of contact with water without agitation, mixing, blending or use of a catalyst, or the like. Access members 42, 44 are caps formed with sugar fibers in one embodiment of the invention. Access members 42, 44 may be concealed in various embodiments of the invention (not shown) by water-soluble film 20 of the invention via folding of the film 20 over at least one of access members 42, 44.

With reference to FIGS. 1 and 2, the immediately dissolvable water-soluble film 20 is formed around concentrate 30 such that the resulting mechanism is cylindrical in shape and adapted to fit through the top of the average water bottle. The diameter of mechanism 10, in a specific embodiment of the invention, is in the range of about 0.55 inches and 0.85 inches. Having a diameter in this range allows mechanism 10 to fit easily through the average water bottle hole without removing the top of the bottle, which is important for ease of use.

The mechanisms are formed on a sheet. Injection molding is not utilized in the manufacturing methods. The mechanisms are formed by helical seam tube rolling. A large roll of premade dissolvable film is taken and cut to the desired width. Moisture and/or adhesive is then administered to the area that overlaps with the proceeding film. The film is just rolled into a helical pattern while the overlap area is pressed together with a hot roller operation. The process is continued to create an extrusion-like tube that can be cut to the length required for the proceeding operations.

Concentrate 30 is then filled into the cylindrical tube through its ends and capped. Capping is achieved using any known method for capping that allows the access member to dissolve in accordance with the invention. One way that capping might be achieved is by using dual sugar filled caps. Using this method, loose sugar fibers are extruded into the tube. The sugar fibers are packed until the fiber forms a ridged cap on the primary end. The desired amount of concentrate is filled into the shell. Then, more loose sugar fibers are extruded into the shell and packed to form another ridged cap on the secondary end.

By another method, embodiments of the invention having folded ends and a sugar fiber cap end are formed by taking the loose sugar fiber and extruding it into the shell. The sugar fiber is then packed until the fiber forms a ridged cap on the primary end. The desired amount of concentrate is filled into the shell and the secondary end is folded and pressure sealed with moisture and/or adhesive. Any edible and dissolvable adhesive may be employed.

In yet another example, embodiments of the invention that have dual folded ends are formed by folding the primary end inward and sealing it with moisture or an adhesive. The sugar fiber is then packed until the fiber forms a rigid cap. The desired amount of concentrate is filled into the shell and the secondary end is folded and pressure sealed with the moisture and/or adhesive.

Those skilled in the art will recognize that manufacturing the claimed and described mechanisms is not limited to the methods described herein. Any other methods of making the claimed mechanisms are conceived to be within the scope of this disclosure.

By way of example, parallel seam tube rolling may be used to make the mechanisms of the invention. A large roll of the water-soluble film described herein is taken and cut to a desired width. The film is rolled around a cylindrical core. After one revolution, moisture and/or adhesive is added to the internal face of the incoming film. A hot roller then presses against the shell and cylindrical core until the heat and pressure fuses the layers of film together. The film is added until the shell reaches the desired thickness described herein. The film is then cut and the shell is rolled between the hot roller and cylindrical core until the moisture is removed from the shell. A tool then ejects the shell and the process is repeated.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

While the present invention has been described in connection with a series of preferred embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

1. An instant dissolving delivery mechanism comprising:
an indissoluble and dispersible concentrate fully encompassed within an immediately dissolvable water-soluble film, the water-soluble film having at least one water-soluble access member therewithin, the at least one water-soluble access member having a water dissolution rate higher than the water dissolution rate of the water-soluble film, the at least one access member being adapted to allow the concentrate to escape the film prior to the dissolution of the film when the film is contacted with water, the at least one access member is of a thickness sufficient to retain the concentrate within the film when not in contact with water, the film being of a thickness sufficient for structural integrity when not in contract with water and adapted to dissolve within five seconds of water contact.

2. The mechanism of claim 1 having a cylindrical shape with two ends.

3. The mechanism of claim 2 wherein one access member lies at each end of the cylindrical shape.

4. The mechanism of claim 1 wherein the concentrate is at least one of a nutritional supplement, drink mix, sweetener, flavor package, or colorant.

5. The mechanism of claim 1 wherein the concentrate is a nutritional supplement.

6. The mechanism of claim 1 wherein the concentrate is an oil-based liquid.

7. The mechanism of claim 2 wherein the cylindrical shape has a diameter in the range of about 0.25 to about 1.16 inches.

8. The mechanism of claim 2 wherein the at least one access member is comprised of sugar fibers.

9. The mechanism of claim 1 wherein the sugar fibers are about 0.25 inches in thickness and have a diameter that is about the same diameter as the mechanism.

10. The mechanism of claim 2 wherein the sugar fibers are about 0.25 inches in thickness and have a diameter that is about the same diameter as the mechanism.

11. The mechanism of claim 1 wherein the mechanism is at least one shape from a group of shapes including, a rectangular prism, a sphere, a cylinder with twisted ends, a rectangular prism with folded and sealed ends, package with sealed and cut ends, or a cylinder with film wafers therein.

12. The mechanism of claim 1 comprising in the range of about 2-160 ml of the concentrate.

13. The mechanism of claim 1 wherein the concentrate further comprises at least one additional component, including but not limited to a sweetener, flavorant, emulsifier, dispersant, and a colorant.

14. The mechanism of claim 11 wherein the mechanism is a cylinder with film wafer therein.

15. The mechanism of claim 1 wherein the water-soluble film is a starch-based emulsion comprising at least one of lecithin and glycerol or a glycerol-based oil film.

16. The mechanism of claim 1 wherein the water-soluble film is at least one of an edible polyvinyl acetate film, polysaccharide film, a protein film, a lipid film, a food safe polyvinyl alcohol-containing film, a piroxicam film, a microcrystalline cellulose and maltodextrin-containing film.

17. The mechanism of claim 1 wherein the water-soluble film is in the range of about 0.0005 to about 0.025 inches thick.

18. The mechanism of claim 17 wherein the water-soluble film is in the range of about 0.0005 to about 0.015 inches thick.

19. An instant dissolving delivery mechanism of cylindrical shape and having two opposite ends, the mechanism comprising:
a nutritional supplement concentrate fully encompassed within a film comprising a starch-based emulsion containing lecithin, glycerol and at least one glycerol-based oil, the film forming the cylindrical shape;
wherein the film of a thickness sufficient for structural integrity when not in contact with water and adapted to dissolve within 5 seconds of water contact,
wherein the water-soluble film is in the range of about 0.0005 and 0.015 inches thick, and
wherein the cylindrical shape has a diameter of about 0.75 to about 1.16 inches,
two water-soluble access members, one residing at an opposite end of the cylindrical shape;
wherein each access member has a water dissolution rate higher than the water dissolution rate of the film,
wherein each access member is specifically adapted to allow the concentrate to escape the film prior to the dissolution of the film when the film is contacted with water, and
wherein the access member has a diameter of about 0.75 inches and a thickness of about 0.25 inches.

20. A method for quickly making a beverage from concentrate comprising placing the mechanism of claim 1 in contact with water.
